(19) United States
(12) Patent Application Publication
(10) Pub. No.: US 2024/0178906 A1
(43) Pub. Date: May 30, 2024

(54) RELAY APPARATUS, NETWORK NODE, CONTROL METHOD, AND COMPUTER-READABLE STORAGE MEDIUM FOR IMPROVING LOCATION ESTIMATION ACCURACY

(71) Applicant: KDDI CORPORATION, Tokyo (JP)

(72) Inventors: Ryuuji KOBAYASHI, Tokyo (JP); Masaya SHIBAYAMA, Tokyo (JP)

(21) Appl. No.: 18/434,382

(22) Filed: Feb. 6, 2024

Related U.S. Application Data
(63) Continuation of application No. PCT/JP2023/003750, filed on Feb. 6, 2023.

(30) Foreign Application Priority Data
Feb. 16, 2022 (JP) 2022-022189

(51) Int. Cl. H04B 7/155; H04W 64/00

(52) U.S. Cl. CPC H04B 7/15507; H04W 64/00

(57) ABSTRACT

A relay apparatus that relays a wireless signal received from a terminal device to a base station device performs control such that if a predetermined reference signal generated using a first sequence is received from the terminal device, the relay apparatus relays, to the base station device, the predetermined reference signal corresponding to a signal generated using a second sequence corresponding to the first sequence, the second sequence being not used by the terminal device to generate the predetermined reference signal.

### CROSS-REFERENCE TO RELATED APPLICATION(S)

This application is a continuation of International Patent Application No. PCT/JP2023/003750 filed on Feb. 6, 2023, which claims priority to and the benefit of Japanese Patent Application No. 2022-022189 filed on Feb. 16, 2022, the entire disclosures of which are incorporated herein by reference.

### BACKGROUND OF THE INVENTION

### Field of the Invention

The present invention relates to a location estimation technique in a wireless communication system that uses a relay apparatus.

### Description of the Related Art

In a cellular communication system, communication services corresponding to the location of a terminal device can be provided to the terminal device by specifying the location. Using the global navigation satellite system (GNSS), for example, the terminal device can identify the location of the terminal device itself by measuring radio waves transmitted from artificial satellites and notify a network of information representing the identified location via a base station device. Meanwhile, there may be cases where, for example, the terminal device cannot use the positioning with the GNSS or disables the GNSS positioning function. In such cases, for example, a method can be used in which a plurality of base station devices measure radio waves transmitted from the terminal device and estimate the location of the terminal device based on the timing at which the radio waves arrive (propagation time).

To expand the coverage area, a cellular communication system may use a relay apparatus (e.g. wireless repeater) that amplifies radio waves arriving from the base station device or the terminal device and outputs the amplified radio waves. In the case of using the relay apparatus, a relay operation performed within the relay apparatus may result in a long delay of radio waves transmitted from the terminal device until arriving at the base station device. This delay may lead to a determination that the terminal device is located further away than it actually is as seen from the base station device, resulting in a greater positioning error.

### SUMMARY OF THE INVENTION

The present invention provides a technique for improving positioning accuracy in a wireless communication system that uses a relay apparatus.

According to one aspect of the present invention, there is provided a relay apparatus that relays a wireless signal received from a terminal device to a base station device, the relay apparatus comprising: one or more processors; and one or more memories that store a computer-readable instruction for causing, when executed by the one or more processors, the one or more processors to function as: a control unit configured to control the relay apparatus such that if a predetermined reference signal generated using a first sequence is received from the terminal device, the relay apparatus relays, to the base station device, the predetermined reference signal corresponding to a signal generated using a second sequence corresponding to the first sequence, the second sequence being not used by the terminal device to generate the predetermined reference signal.

According to one aspect of the present invention, there is provided a network node comprising: one or more processors; and one or more memories that store a computer-readable instruction for causing, when executed by the one or more processors, the one or more processors to function as: an acquisition unit configured to acquire a timing at which a predetermined signal transmitted from a terminal device is detected by a base station device; and an estimation unit configured to estimate a location of the terminal device based on the timing, wherein the estimation unit estimates the location of the terminal device using the acquired timing if the predetermined signal generated using a first sequence is detected by the base station device; and estimates the location of the terminal device using a corrected timing obtained by correcting the timing such that the predetermined signal is regarded as arriving earlier than the acquired timing by a time associated with relay processing performed by a relay apparatus, if the predetermined signal corresponding to a signal generated using a second sequence corresponding to the first sequence, the second sequence being not used by the terminal device to generate the predetermined signal, is detected by the base station device.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of a configuration of a wireless communication system.

FIG. 2 is a diagram illustrating an example of SRS relay processing.

FIG. 3 is a diagram showing an example of a hardware configuration of a relay apparatus and a network node.

FIG. 4 is a diagram showing an example of a functional configuration of the relay apparatus.

FIG. 5 is a diagram showing an example of a functional configuration of the network node.

FIG. 6 is a diagram showing an example of a flow of processing performed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Sonfiguration

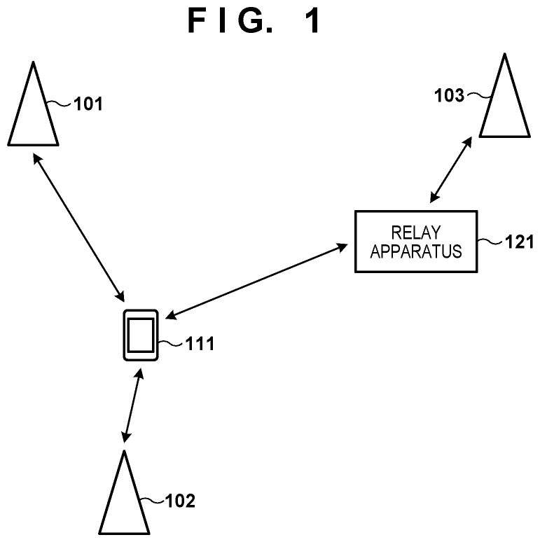

FIG. 1 shows an example of a configuration of a wireless communication system according to an embodiment. The wireless communication system may be a cellular communication system compliant with Long Term Evolution (LTE) or fifth-generation (5G) cellular communication standards, in which a terminal device connects to a base station device and performs wireless communication. Note that the wireless communication system employs a relay apparatus in order to improve wireless communication quality at cell edges and in dead zones. Note that FIG. 1 shows an example in which base station devices 101 to 103 and a terminal device 111 are present, and a relay apparatus 121 is prepared in order to relay communication of the base station device 103, for example. The terminal device 111 can connect and communicate with any of the base station devices 101 to 103. Note that when the terminal device 111 connects to the base station device 103, the connection is established via the relay apparatus 121. Note that the relay apparatus 121 may be, for example, a non-regenerative relay apparatus (wireless repeater) that amplifies and outputs an incoming signal without performing demodulation or the like.

In the wireless communication system, each base station device detects a predetermined reference signal transmitted from the terminal device 111, and estimates the location of the terminal device 111 based on the timing of the detection. For example, each of the base station devices 101 to 103 detects the predetermined reference signal transmitted from the terminal device 111, and the timings of the detection are consolidated in any of the base station devices or a network node such as a positioning server that is separately prepared from these base station devices. Based on the timings of the detection at three or more base station devices, for example, the network node can estimate the location of the terminal device 111 based on differences in the timing of receiving the predetermined reference signal between these base station devices.

Meanwhile, the base station device 103 receives the predetermined reference signal transmitted from the terminal device 111 via the relay apparatus 121. For this reason, the time taken for the predetermined reference signal transmitted from the terminal device 111 to be received by the base station device 103 does not correspond to the length of a radio wave propagation path between the base station device 103 and the terminal device 111 via the relay apparatus 121 due to, for example, delays in processing such as amplification and output performed by the relay apparatus 121, resulting in a greater error in the result of estimating the location of the terminal device 111. In contrast, if the network node can recognize that the predetermined reference signal has arrived at the base station device 103 via the relay apparatus 121, the timing of receiving the predetermined reference signal at the base station device 103 can be corrected while assuming that the predetermined reference signal arrived at the base station device 103 earlier by the processing delay in the relay apparatus 121. The corrected timing serves is equivalent to the timing corresponding the length of the radio wave propagation path between the base station device 103 and the terminal device 111 via the relay apparatus 121. In this case, the network node may estimate the location of the terminal device 111 by assuming that the predetermined reference signal from the terminal device 111 has directly arrived at the base station device 103 at the corrected timing, for example. In addition, the network node may, for example, further correct the corrected timing to a timing that is further advanced by the time corresponding to the distance between the base station device 103 and the relay apparatus 121, and assume that the predetermined reference signal arrived at the relay apparatus 121 at the recorrected timing. The network node can improve location estimation accuracy by estimating the location of the terminal device 111 based on the differences in the reception timing between the base station device 101, the base station device 102, and the relay apparatus 121.

Meanwhile, if the relay apparatus 121 is a wireless repeater that is configured to amplify an incoming wireless signal and transmit the amplified signal without demodulation, it is impossible to determine whether the signal arriving at the base station device 103 is a signal arriving directly from the terminal device 111 or a signal arriving via the relay apparatus 121. For this reason, the network node cannot appropriately correct the reception timing. In view of these circumstances, processing performed by the relay apparatus 121 of the present embodiment makes it possible to determine whether a signal arriving at the base station device 103 is a signal arriving directly from the terminal device 111 or a signal arriving via the relay apparatus 121. This enables appropriate correction of the reception timing.

When receiving the predetermined reference signal from the terminal device 111, the relay apparatus 121 of the present embodiment does not amplify and output the signal as-is, but transmits a signal after subjected to predetermined processing to the base station device 103. For example, the predetermined reference signal transmitted from the terminal device 111 is generated using a first sequence designated by the network side for the terminal device 111. In this case, the base station device 103 can detect the predetermined reference signal using the first sequence if the predetermined reference signal arrives at a predetermined power level or higher. The present embodiment enables the relay apparatus 121 to also detect the predetermined reference signal using the first sequence. When receiving the predetermined reference signal generated using the first sequence, the relay apparatus 121 relays a predetermined reference signal that is generated using a second sequence corresponding to the first sequence but different from the first sequence, to the base station device 103. Here, the second sequence may be a sequence that is not used when the terminal device 111 transmits the predetermined reference signal. With this configuration, when detecting the predetermined reference signal using the first sequence, the base station device 103 can determine that the predetermined reference signal has arrived directly from the terminal device 111. When detecting the predetermined reference signal using the second sequence, the base station device 103 can determine that the predetermined reference signal has arrived via the relay apparatus 121.

Note that the terminal device 111 uses, for example, the first sequence notified from the network side when transmitting the predetermined reference signal, but the sequence that can be used as this first sequence may have a plurality of patterns. For example, if the predetermined reference signal is a sounding reference signal (SRS), the terminal device 111 may use a predetermined sequence prepared in advance as-is as the first sequence, or use, as the first sequence, a sequence obtained by applying a cyclic shift to the predetermined sequence by a predetermined shift amount. Note that a cyclic shift is obtained by changing the starting position of a predetermined sequence and adding a partial sequence that is present forward of the leading position to the tail of the sequence. By, for example, applying a cyclic shift with a shift amount of 10 to a sequence with a length of 100 in which indexes 0 to 99 are appended to respective symbols, a sequence is obtained with a starting position being 10 and with a partial sequence with indexes 0 to 9 appended after the symbol with the index 99. Here, the SRS is transmitted every predetermined number of subcarriers. In the case where the SRS is transmitted every two subcarriers, eight patterns of shift amounts are defined, and eight patterns of sequences corresponding to these shift amounts may each be used as the first sequence. In contrast, the relay apparatus 121 may use a sequence different from any of the eight sequences as the second sequence. For example, eight patterns of second sequences corresponding to the eight respective first sequences may be prepared. The relay apparatus 121 may identify which of the eight patterns of the first sequences has been used to generate the reference signal received from the terminal device 111, identify a sequence corresponding to the identified sequence from among the second sequences, generate a predetermined reference signal using the identified second sequence, and transfer the generated reference signal to the base station device 103. Note that the second sequence may be a sequence that is not related to the predetermined sequence used when generating the first sequence. Further, the second sequence in one example may be a sequence orthogonal to the predetermined sequence used when generating the first sequence. By preparing second sequences corresponding to respective sequences each of which can be used as the first sequence, it is possible to identify which of the sequences each of which can be used as the first sequence the predetermined reference signal detected by the base station device 103 corresponds to, and identify the predetermined reference signal transmitted by which terminal device the detected predetermined reference signal corresponds to.

As mentioned above, the predetermined reference signal may be an SRS. In this case, the first sequence is a predetermined sequence itself or a sequence obtained by applying a cyclic shift by the first shift amount to that predetermined sequence, as mentioned above. In this case, the second sequence may be a sequence obtained by applying a cyclic shift by a second shift amount that cannot be taken as the first shift amount to the predetermined sequence. For example, if the first shift amount is 0, 10, 20, 30, or 40, the second shift amount may be set to 50, 60, 70, 80, or 90. In this case, (first shift amount+50) may be used as the second shift amount, for example. Note that the relay apparatus 121 may identify the second shift amount based on the first shift amount corresponding to the received SRS and generate a new SRS using a sequence corresponding to the identified second shift amount. However, in this case, the relay apparatus 121 may transform the newly generated SRS and transmit the transformed SRS to the base station device 103 in a format that reflects reception quality or the like of the received SRS, i.e. in a format in which the properties of the SRS received from the terminal device 111 are not lost. Note that the relay apparatus 121 may alternatively transform the received SRS by applying a cyclic shift by the corresponding shift amount to the received SRS and transmit the SRS corresponding to the second shift amount to the base station device 103 without generating a new SRS.

It is detected that a predetermined signal generated using a known sequence has been transmitted, by detecting a peak of a value calculated by means of correlation detection using the known sequence. In contrast, in the case where another sequence is generated by applying a cyclic shift to a predetermined sequence, a predetermined signal generated using the other sequence may also generate a peak at a timing shifted by the time corresponding to the shift amount when correlation detection using the predetermined sequence is performed. At this time, if a shift of the timing at which the peak is generated in the correlation detection using the predetermined sequence is included in the range of a cyclic prefix appended to one OFDM (orthogonal frequency division multiplexing) symbol, an error may occur in determining which shift amount the peak corresponds to. That is, it is envisioned that a certain delay wave occurs on an OFDM symbol generated by a certain sequence, and a cyclic prefix is therefore appended. Thus, if correlation detection is performed using this sequence, a peak corresponding to the delayed wave is detected within the range of the cyclic prefix. Meanwhile, if correlation detection is performed using a different sequence obtained by applying a cyclic shift to this sequence, a peak occurs at a shifted timing. If, at this time, the shift amount of the cyclic shift is not sufficiently large, the shift of the timing may not be large, and for example, the peak may occur at the same timing as the delayed wave. In this case, it becomes impossible to determine whether the appearing peak corresponds to a sequence previous to the cyclic shift or a sequence after the cyclic shift. Therefore, in the present embodiment, the shift amount may be set such that the shift of the timing at which the peak appears exceeds the length of the cyclic prefix of the SRS. Note that this shift amount may also be applied to the relationship between two second sequences.

Note that the shift amount is specified based on the length of the cyclic prefix, for example. In one example, up to 14 patterns of shift amounts can be obtained. Using this, for example, for the SRS transmitted from the aforementioned terminal device 111, seven (or less) out of the 14 patterns can each be used as the first shift amount, and for the SRS transferred by the relay apparatus 121, the remaining seven (or less) out of the 14 patterns can be each be used as the second shift amount. For example, a configuration is possible in which indexes 0 to 13 are assigned to the 14 respective patterns, the patterns with the indexes 0 to 6 are each used as the first shift amount, and a pattern corresponding to “the index of the first shift amount+7” as the second shift amount. With this configuration, it is possible to determine that a reference signal has directly arrived from the terminal device 111 if the reference signal generated using the first sequence corresponding to the pattern of the shift amount of any of the indexes 0 to 6 is detected, and that a reference signal has been relayed by the relay apparatus 121 if the reference signal generated using the second sequence corresponding to the pattern of the shift amount of any of the indexes 7 to 13 is detected. Note that, for example, the second shift amount may be a shift amount obtained by adding a shift amount exceeding the maximum value of the first shift amount to this first shift amount. That is, it may be determined that a reference signal has been relayed by the relay apparatus 121 if the predetermined reference signal corresponding to a sequence with a shift amount exceeding the maximum value of the first shift amount is detected.

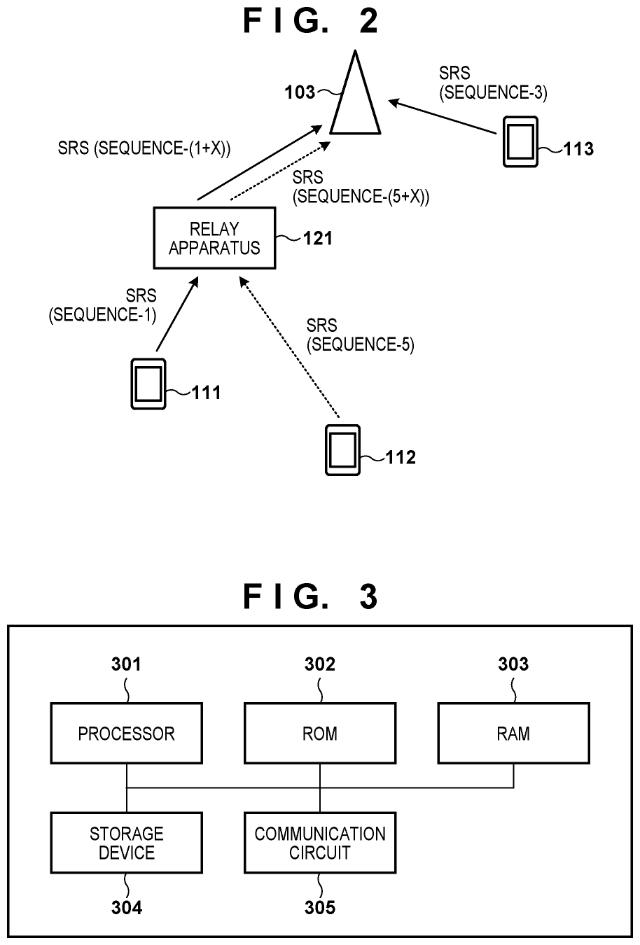

FIG. 2 shows an outline of the operation performed when the relay apparatus 121 performs the above-described processing. Note that here, the sequence of the index 0 to X−1 (X≥6) is used as the first sequence, and the sequence of the index X to 2X−1 is used as the second sequence. Note that in one example, the indexes 0 to 2X−1 may correspond to different shift amounts. In this case, the first sequence and the second sequence are generated as sequences obtained by applying a cyclic shift by different shift amounts to the same predetermined sequence. Further, the first sequence and the second sequence may be sequences obtained by applying a cyclic shift to different predetermined sequences. Furthermore, sequences corresponding to different indexes within the range of the first sequence or the second sequence may be mutually unrelated sequences that are not in a relationship of a cyclic shift. Note that in FIG. 2, a sounding reference signal (SRS) is used as the predetermined reference signal, and the first sequence and the second sequence are sequences obtained by applying a cyclic shift by different shift amounts to a common predetermined sequence.

In FIG. 2, the terminal devices 111 and 112 are present at locations at which the terminal devices 111 and 112 can communicate with the base station device 103 via the relay apparatus 121, and the terminal device 113 is present at a location at which the terminal device 113 can directly communicate with the base station device 103. At this time, the connected base station device, for example, may notify each terminal device of information (e.g. the first shift amount) that enables the first sequence of the index 0 to X−1 to be generated as a sequence to be used when generating the SRS. Further, the base station device that is a communication relay target may notify the relay apparatus of information (e.g. the second shift amount, a shift amount to be added to the first shift amount etc.) that enables the second sequence corresponding to the first sequence of the index 0 to X−1 to be generated. The terminal device 111, the terminal device 112, and the terminal device 113 generate SRSs using the sequences of the indexes “1”, “5”, and “3”, respectively, and transmit the generated SRSs. At this time, the SRS transmitted from the terminal device 113 directly arrives at the base station device 103 as-is. The base station device 103 can detect the SRS from the terminal device 113 generated using the sequence of the index “3” by performing SRS detection processing using the sequences of the indexes “1” to “X−1”. This allows the base station device 103 to identify that the SRS from the terminal device 113 has arrived directly, not via the relay apparatus 121.

On the other hand, the SRSs transmitted by the terminal devices 111 and 112 are relayed by the relay apparatus 121. In this case, since the SRS received from the terminal device 111 was generated using the first sequence of the index “1”, the relay apparatus 121 transfers an SRS corresponding to the second sequence of the index “1+X”, which corresponds to the index “1”, to the base station device 103. Note that the relay apparatus 121 generates the SRS using the second sequence of the index “1+X”, or transforms the received SRS by applying a cyclic shift by a shift amount corresponding to the index “X”, and outputs the generated or transformed SRS. Similarly, since the SRS received from the terminal device 112 was generated using the first sequence of the index “5,” the relay apparatus 121 transfers an SRS corresponding to the second sequence of the index “5+X”, which corresponds to the index “5”, to the base station device 103. The base station device 103 can detect the SRSs corresponding to the sequences of the indexes “1+X” and “5+X” by performing SRS detection processing using the sequences of the indexes “X” to “2X−1”. When detecting an SRS corresponding to a sequence of the index “1+X”, the base station device 103 can identify that this SRS has been received via the relay apparatus 121. When detecting an SRS corresponding to the second sequence of the index “1+X”, the base station device 103 can identify that this SRS corresponds to the first sequence of the index “1”. Since the terminal device 111 is configured to use the first sequence of the index “1”, the base station device 103 can identify that the SRS has been transmitted by the terminal device 111 and received via the relay apparatus 121. Similarly, when detecting an SRS corresponding to a sequence of the index “5+X”, the base station device 103 can identify that the SRS has been transmitted from the terminal device 112 and received via the relay apparatus 121. Then, the base station device 103 or the network node that performs positioning deals with the reception timing at which the SRS was actually received via the relay apparatus 121 as a timing earlier by the time of a delay in processing performed by the relay apparatus 121 (i.e. corrects the reception timing), thereby improving positioning accuracy for the terminal devices 111 and 112.

Note that each of the aforementioned SRSs is an example of the predetermined reference signal, and another reference signal may alternatively be used. For example, a reference signal newly defined for location measurement may alternatively be used. Further, the first sequence and the second sequence need not be sequences generated by applying a cyclic shift to a predetermined sequence. That is, it is sufficient if the predetermined reference signal is generated using a sequence selected from predetermined candidates so as to be detectable by the base station device, the first sequence and the second sequence are different from each other, and the first sequence and the second sequence are in a one-to-one mapping relationship.

Note that, to perform the aforementioned processing, the relay apparatus 121 has a function of at least identifying a predetermined reference signal, transforming and amplifying the predetermined reference signal, and outputting the resulting signal. For example, the relay apparatus 121 may identify the first sequence by performing demodulation processing on the received predetermined reference signal, generate the second sequence by applying a cyclic shift to the first sequence, and regenerate and relay the predetermined reference signal based on the second sequence. Note that when the relay apparatus 121 identifies the first sequence used to generate the received predetermined reference signal, the relay apparatus 121 may transmit a predetermined reference signal that is separately prepared using the second sequence corresponding to the first sequence, instead of the received reference signal, to the base station device 103. Note that the relay apparatus 121 may be configured to output the transformed predetermined reference signal or the predetermined reference signal based on the separately prepared second sequence after a predetermined time elapses from the timing of receiving the predetermined reference signal.

Also, for a signal different from the predetermined reference signal, the relay apparatus 121, as a wireless repeater, may amplify the signal and transfer the amplified signal to the base station device 103 without performing demodulation processing on the signal. That is, the relay apparatus 121 may function as a wireless repeater that has a function of performing the aforementioned processing on the predetermined reference signal and performing non-regenerative relaying for other signals.

### Apparatus Configuration

FIG. 3 is a diagram showing an example of a hardware configuration of the relay apparatus 121. The relay apparatus 121 in one example includes a processor 301, a ROM 302, a RAM 303, a storage device 304, and a communication circuit 305. The processor 301 is a computer that includes at least one processing circuit, such as a general-purpose CPU (Central Processing Unit) or an ASIC (Application-Specific Integrated Circuit), and performs processing of the entire apparatus and the above-described processing by loading and executing programs stored in the ROM 302 or the storage device 304. The ROM 302 is a read-only memory for storing information such as programs and various parameters related to the processing performed by the relay apparatus 121. The RAM 303 functions as a workspace for the processor 301 to execute the programs, and is also a random-access memory for storing temporary information. The storage device 304 is constituted by, for example, a removable external storage device or the like. The communication circuit 305 is constituted by, for example, a circuit for wireless communication, such as LTE or 5G. Although FIG. 2 shows one communication circuit 305, the relay apparatus 121 may have a plurality of communication circuits. For example, the relay apparatus 121 may have wireless communication circuits and antennas for LTE and 5G.

Note that the network node (e.g. any of the base station devices or the positioning server) that estimates the location of the terminal device 111 may also have the same hardware configuration as that shown in FIG. 3.

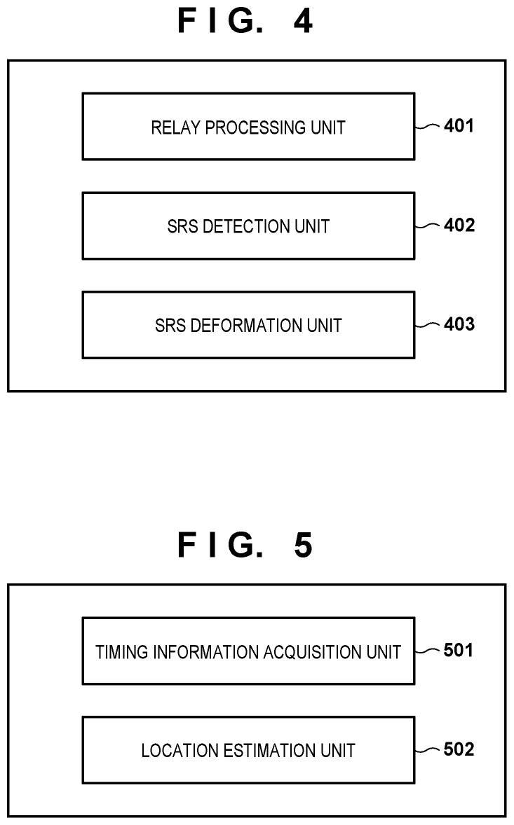

FIG. 4 is a diagram showing an example of a functional configuration of the relay apparatus 121. The relay apparatus 121 includes, for example, a relay processing unit 401, an SRS detection unit 402, and an SRS deformation unit 403. Note that these functional units may be implemented by, for example, the processor 301 executing the programs stored in the ROM 302 or the storage device 304. However, not limited thereto, some or all of these functional units may be implemented using dedicated hardware, for example. Note that since the processing to be performed by the relay apparatus 121 has been described above, the functional configuration of the relay apparatus 121 is only roughly outlined here.

The relay processing unit 401 amplifies a signal received from the terminal device 111 and transmits the amplified signal to the base station device 103, and also amplifies a signal received from the base station device 103 and transmits the amplified signal to the terminal device 111. The relay apparatus 121 is, for example, a non-regenerative relay apparatus (wireless repeater), and the relay processing unit 401 is configured to amplify signals other than the predetermined reference signal used for positioning such as the SRS (and also perform frequency conversion if necessary), without performing demodulation or decoding, and output the resulting signals. Note that if the relay apparatus 121 is a regenerative relay apparatus, the relay processing unit 401 may be configured to demodulate and decode a received signal, encode and modulate a resulting data sequence, and regenerate and output a wireless signal.

The SRS detection unit 402 performs SRS detection processing at a frequency and a time resource at which an SRS (predetermined reference signal) may be transmitted. For example, the SRS detection unit 402 may execute correlation detection at that frequency and time resource by using the first sequence that may be used by the terminal device 111 to generate the SRS, and it may be determined that an SRS has arrived if a peak appears in a correlation value. If the SRS detection unit 402 detects an SRS, the SRS transforming unit 403 transforms the SRS into a format that enables the base station device 103 to identify that the SRS has arrived via the relay apparatus 121. For example, the SRS transforming unit 403 may apply a cyclic shift by a predetermined shift amount to the first sequence corresponding to the received SRS, and output an SRS corresponding to the second sequence that is not used by the terminal device 111 for SRS transmission. Note that the SRS transforming unit 403 may newly generate an SRS using, for example, the second sequence corresponding to the first sequence used by the SRS detection unit 402 for SRS detection. The transformed or newly generated SRS output by the SRS transforming unit 403 is transmitted to the base station device 103 via the relay processing unit 401.

FIG. 5 is a diagram showing an example of a functional configuration of the network node that estimates the location of the terminal device 111. The network node includes, for example, a timing information acquisition unit 501 and a location estimation unit 502. Note that these functional units may be implemented by, for example, the processor 301 executing the programs stored in the ROM 302 or the storage device 304. However, not limited thereto, some or all of these functional units may be implemented using dedicated hardware, for example.

The timing information acquisition unit 501 acquires information regarding the timing at which an SRS (predetermined reference signal) from the terminal device was detected by each of the base station devices. For example, the timing information acquisition unit 501 acquires information indicating the timing of actually receiving an SRS, from a base station that directly received the SRS from the terminal device 111. Also, the timing information acquisition unit 501 acquires, from the base station that received the SRS from the terminal device 111 via the relay apparatus 121, information indicating a timing that has been corrected such that the SRS is regarded as arriving earlier than the timing at which the SRS was actually received by the time associated with relay processing performed by the relay apparatus 121, for example. Note that the timing information acquisition unit 501 may acquire, from the base station that received the SRS from the terminal device 111 via the relay apparatus 121, information indicating the timing of actually receiving the SRS and information with which it can be identified that the SRS was received via the relay apparatus 121. In this case, the timing information acquisition unit 501 may correct the timing such that the SRS is regarded as arriving earlier than the timing of actually being received by the time associated with relay processing performed by the relay apparatus 121, and acquire the corrected timing information. Note that the time associated with relay processing performed by the relay apparatus 121 may be, but is not limited to, the time required for the relay processing itself. For example, the time associated with the relay processing may include the time corresponding to an expected value of a path difference between the direct distance from the location of the terminal device 111 to the location of the base station device and the distance of a path from the terminal device 111 to the base station device when the SRS is received via the relay apparatus 121. For example, the location of at least some of the terminal devices whose communication is relayed by the relay apparatus 121 may be measured in advance using the GNSS or the like, and the expected value of the path difference may be identified from the distribution of the measurement results. In one example, if the SRS is received after being relayed by the relay apparatus 121, the reception timing may be corrected such that the SRS is regarded as arriving at the base station device earlier than the actual reception timing by this expected value of the path difference.

The location estimation unit 502 performs positioning based on a time difference of arrival (TDOA), for example. That is, the location estimation unit 502 estimates the location of the terminal device 111 based on a difference in the timing of receiving the SRS from the terminal device 111 that is acquired from a plurality of (e.g. three) base station devices by the timing information acquisition unit 501. Note that the location estimation unit 502 estimates the location based on the TDOA using the timing of actually receiving the SRS if the SRS arrived at the base station device without being relayed by the relay apparatus 121, and using the corrected timing obtained as mentioned above if the SRS was received after being relayed by the relay apparatus 121.

### Processing Flow

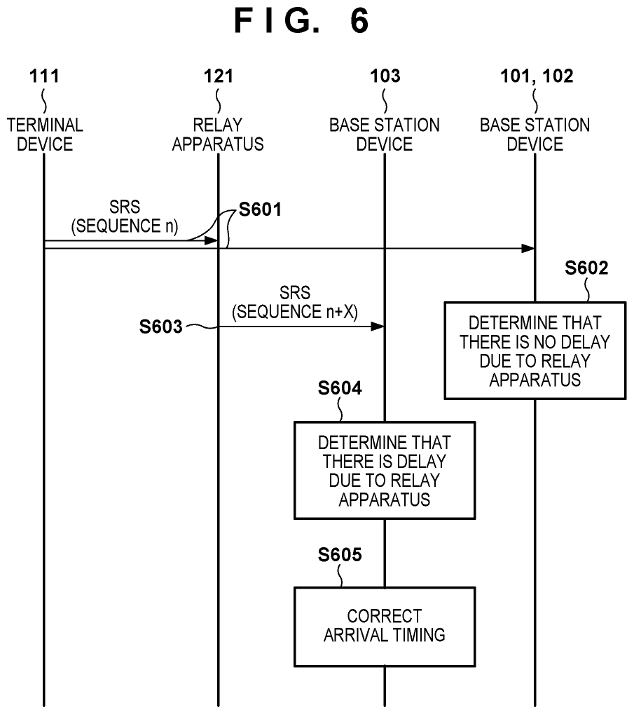

Next, an example of a flow of processing performed in the wireless communication system is described with reference to FIG. 6. Note that this example describes processing in which when an SRS is received at each base station device, it is determined whether or not the SRS was received via the relay apparatus 121, and the reception timing is corrected if the SRS was received via the relay apparatus 121. That is, processing performed when the network node actually estimates the location of the terminal device 111 is different from conventional processing only in that the location estimation is performed using the corrected timing for the SRS received via the relay apparatus 121, and the description here is therefore omitted.

In the example in FIG. 6, the terminal device 111 generates an SRS using the first sequence (e.g. a sequence of an index n (0≤n≤X−1)) and transmits the generated SRS to the surrounding area (S601). The base station devices 101 and 102 recognize that the SRS corresponding to the sequence of the index n has been received by performing SRS detection processing, and determine that this SRS has not been relayed by the relay apparatus and has not been affected by a delay due to relay processing (S602). Therefore, the base station devices 101 and 102 do not perform processing to correct the reception timing. Meanwhile, the base station device 103 is to receive the SRS via the relay apparatus 121. In this case, in response to receiving the SRS generated using the first sequence of the index n, the relay apparatus 121 transforms the received SRS or newly generates an SRS using the second sequence of an index n+X, which corresponds to the index n, and transmits the transformed or generated SRS to the base station device 103 (S603). The base station device 103 recognizes that the SRS corresponding to the sequence of the index n+X has been received by performing SRS detection processing. The base station device 103 thus determines that the detected SRS has been relayed by the relay apparatus 121 and affected by a delay due to relay processing (S604). Then, the base station device 103 corrects the reception timing in order to regard the timing of receiving the SRS as being earlier by the delay due to relay processing (S605).

In one example, the base station devices 101 and 102 provide the timing of actually receiving the SRS to a predetermined network node (e.g. any of the base station devices, the positioning server etc.), and the base station device 103 provides the corrected reception timing to this network node. Then, the network node may estimate the location of the terminal device 111 based on the reception time differences based on the information regarding the provided timings of receiving the SRS. Also, the base station devices 101 to 103 may provide the network node with information indicating the timing of actually receiving the SRS and information indicating the sequences used to detect the SRS, and the network node may determine whether or not to correct the timing and estimate the location of the terminal device 111, using the provided information.

As described above, the present embodiment can improve the accuracy of estimating the location of the terminal device 111 since the timing of receiving the SRS from the terminal device 111 is identified after removing the influence of a delay due to relay processing performed by the relay apparatus 121. It is therefore possible to contribute to Goal 9 of the SDGs (Sustainable Development Goals) led by the United Nations: “Build resilient infrastructure, promote sustainable industrialization, and expand innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A relay apparatus that relays a wireless signal received from a terminal device to a base station device, the relay apparatus comprising:
one or more processors; and
one or more memories that store a computer-readable instruction for causing, when executed by the one or more processors, the one or more processors to function as:
a control unit configured to control the relay apparatus such that if a predetermined reference signal generated using a first sequence is received from the terminal device, the relay apparatus relays, to the base station device, the predetermined reference signal corresponding to a signal generated using a second sequence corresponding to the first sequence, the second sequence being not used by the terminal device to generate the predetermined reference signal.

2. The relay apparatus according to claim 1,
wherein the first sequence is a sequence obtained by applying a cyclic shift by a first shift amount to a predetermined sequence, or is the predetermined sequence itself, and the second sequence is a sequence obtained by applying, to the predetermined sequence, a cyclic shift by a second shift amount that is not used as the first shift amount.

3. The relay apparatus according to claim 2,
wherein the second shift amount is an amount obtained by adding, to the first shift amount, a shift amount exceeding a maximum value of the first shift amount usable to generate the first sequence.

4. The relay apparatus according to claim 2,
wherein the number of patterns of the first shift amount and the number of patterns of the second shift amount are set based on a length of a cyclic prefix appended to an orthogonal frequency division multiplexing (OFDM) symbol.

5. The relay apparatus according to claim 1,
wherein the predetermined reference signal is a sounding reference signal (SRS).

6. The relay apparatus according to claim 1,
wherein if a signal different from the predetermined reference signal is received from the terminal device, the relay apparatus amplifies the received signal and transfers the amplified signal to the base station device without performing processing to demodulate the signal.

7. A network node comprising:
one or more processors; and
one or more memories that store a computer-readable instruction for causing, when executed by the one or more processors, the one or more processors to function as:
an acquisition unit configured to acquire a timing at which a predetermined signal transmitted from a terminal device is detected by a base station device; and
an estimation unit configured to estimate a location of the terminal device based on the timing,
wherein the estimation unit
estimates the location of the terminal device using the acquired timing if the predetermined signal generated using a first sequence is detected by the base station device; and
estimates the location of the terminal device using a corrected timing obtained by correcting the timing such that the predetermined signal is regarded as arriving earlier than the acquired timing by a time associated with relay processing performed by a relay apparatus, if the predetermined signal corresponding to a signal generated using a second sequence corresponding to the first sequence, the second sequence being not used by the terminal device to generate the predetermined signal, is detected by the base station device.

8. A control method performed by a relay apparatus that relays a wireless signal received from a terminal device to a base station device, the method comprising:
controlling the relay apparatus such that if a predetermined reference signal generated using a first sequence is received from the terminal device, the relay apparatus relays, to the base station device, the predetermined reference signal corresponding to a signal generated using a second sequence corresponding to the first sequence, the second sequence being not used by the terminal device to generate the predetermined reference signal.

9. A control method performed by a network node, the method comprising:
acquiring a timing at which a predetermined signal transmitted from a terminal device is detected by a base station device; and
estimating a location of the terminal device based on the timing,
wherein in the estimating,
the location of the terminal device is estimated using the timing that is recorded, if the predetermined signal generated using a first sequence is detected by the base station device; and
the location of the terminal device is estimated using a corrected timing obtained by correcting the timing such that the predetermined signal is regarded as arriving earlier than the timing that is recorded by a time associated with relay processing performed by a relay apparatus, if the predetermined signal corresponding to a signal generated using a second sequence corresponding to the first sequence, the second sequence being not used by the terminal device to generate the predetermined signal, is detected by the base station device.

10. A non-transitory computer-readable storage medium that stores a program for causing a computer included in a relay apparatus to execute a control method, wherein the control method comprises
controlling the relay apparatus such that if a predetermined reference signal generated using a first sequence is received from the terminal device, the relay apparatus relays, to the base station device, the predetermined reference signal corresponding to a signal generated using a second sequence corresponding to the first sequence, the second sequence being not used by the terminal device to generate the predetermined reference signal.

11. A non-transitory computer-readable storage medium that stores a program for causing a computer included in a network node to execute a control method, wherein the control method comprises
acquiring a timing at which a predetermined signal transmitted from a terminal device is detected by a base station device; and
estimating a location of the terminal device based on the timing,
wherein in the estimating,
the location of the terminal device is estimated using the timing that is recorded, if the predetermined signal generated using a first sequence is detected by the base station device; and
the location of the terminal device is estimated using a corrected timing obtained by correcting the timing such that the predetermined signal is regarded as arriving earlier than the timing that is recorded by a time associated with relay processing performed by a relay apparatus, if the predetermined signal corresponding to a signal generated using a second sequence corresponding to the first sequence, the second sequence being not used by the terminal device to generate the predetermined signal, is detected by the base station device.
